(19) United States
(12) Patent Application Publication
(10) Pub. No.: US 2016/0088645 A1
(43) Pub. Date: Mar. 24, 2016

(54) MECHANISMS TO PREVENT TCP TIMEOUTS IN DUAL SIM DUAL ACTIVE DEVICES

(71) Applicant: QUALCOMM Incorporated, San Diego, CA (US)

(72) Inventors: Abeezar Burhan, Middlesex (GB); Neha Goel, Surrey (GB); Mungal Singh Dhanda, Slough (GB)

(21) Appl. No.: 14/503,694

(22) Filed: Oct. 1, 2014

Related U.S. Application Data
(60) Provisional application No. 62/054,234, filed on Sep. 23, 2014.

(51) Int. Cl. H04W 72/10; H04L 12/851

(52) U.S. Cl. CPC H04W 72/10; H04L 47/24

(57) ABSTRACT

A method includes: determining a first protocol data unit (PDU) priority for a first PDU and a second PDU priority for a second PDU; tagging the first PDU with the first PDU priority and the second PDU with the second PDU priority; determining to transmit one of the first PDU and the second PDU based at least in part on the first PDU priority and the second PDU priority; and transmitting a one of the first PDU and the second PDU having a higher PDU priority.

### CROSS-REFERENCE TO RELATED APPLICATION

This application claims the benefit of U.S. Provisional Patent Application No. 62/054,234 entitled “Mechanisms to Prevent TCP Timeouts in Dual SIM Dual Active Devices” filed Sep. 23, 2014, the disclosure of which is incorporated herein in its entirety by reference.

### BACKGROUND

In a dual-subscriber identity module (SIM), dual active (DSDA) mobile communication device, two radio frequency (RF) communication circuits (RF chains) are available to support activities performed on two separate subscriptions. When two RF chains are operating simultaneously and within close proximity, both in- and outbound data can be corrupted and rendered undecipherable by interference. Generally, the receiver in one RF chain is subject to desensitization caused by the noise generated by the transmitter in the other RF chain nearby. The conventional solution in this case is to inhibit (i.e., blank) the data transmission performed on one subscription in favor of the data reception performed on the other subscription.

Alternately, both subscriptions may attempt to transmit data at the same time. In some types of DSDA devices, both RF chains are able to can transmit but cannot transmit simultaneously without interfering with each other. In other types of DSDA devices, transmissions from both subscriptions are accomplished by time sharing a single transmitter RF chain. In either case, the data transmission on one subscription will need to defer to the data transmission on the other subscription.

In one common scenario, a first subscription may be performing an uplink (Tx) data transfer while a second subscription is engaged in a voice call. In order to avoid performance degradation in the RF chain associated with the second subscription, the RF chain associated with the first subscription is set to blank its data transmission. However, as a result of blanking the transmission, all of the outbound data for the first subscription is delayed, including Transmission Control Protocol (TCP) and Internet Control Message Protocol (ICMP) packets, and non-access stratum (NAS) procedural data.

For TCP-based data exchanges, certain types of data packets (e.g., ACK, SYN) are necessary to successfully establish a connection (i.e., three-way handshake), terminate a connection (i.e., four-way handshake), and transfer data (i.e., deliver of an ordered and error-checked stream of packets).

Also, ICMP messages are used for diagnostic and control purposes. For example, a DSDA device may transmit an ICMP echo request (“ping”) to probe the reachability of a host or a network. Finally, NAS procedures support the mobility (i.e., Mobility Management) and connectivity (i.e., Session Management) of an inherently mobile DSDA device. Failure to timely communicate these types of data triggers TCP timeouts, causes abnormalities in the release of the uplink temporary block flow (TBF), and generally compromises the data throughput at the first subscription.

### SUMMARY

Apparatuses and methods for preventing TCP timeouts are provided.

According to the various embodiments, there is provided a method. The method may include: determining a first protocol data unit (PDU) priority for a first PDU and a second PDU priority for a second PDU; tagging the first PDU with the first PDU priority and the second PDU with the second PDU priority; determining to transmit one of the first PDU and the second PDU based at least in part on the first PDU priority and the second PDU priority; and transmitting a one of the first PDU and the second PDU having a higher PDU priority.

According to various embodiments, there is provided a method. The method may include: determining a first macro priority for a first activity; determining a second macro priority for a second activity; determining to perform one of the first activity and the second activity based at least in part on the first macro priority and the second macro priority.

According to the various embodiments, there is provided a mobile communication device. In some embodiments, the mobile communication device may include: a control unit, a first radio frequency (RF) chain, and a second RF chain.

The control unit may be configured to: determine a first PDU priority for a first PDU and a second PDU priority for a second PDU; tag the first PDU with the first PDU priority and the second PDU with the second PDU priority; and determine to transmit one of the first PDU and the second PDU based at least in part on the first PDU priority and the second PDU priority. One of the first RF chain and the second RF chain may be configured to transmit a one of the first PDU and the second PDU having a higher PDU priority.

According to various embodiments, there is provided a mobile communication device. In some embodiments, the mobile communication device may include: a control unit, a first RF chain, and a second RF chain.

The control unit may be configured to: determine a first macro priority for a first activity; determine a second macro priority for a second activity; determine to perform one of the first activity and the second activity based at least in part on the first macro priority and the second macro priority. One of the first RF chain and the second RF chain may be configured to perform a one of the first activity and the second activity having a higher macro priority.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a block diagram illustrating a mobile communication device according to various embodiments;

FIG. 2A is a flowchart illustrating a process for preventing TCP timeouts according to various embodiments;

FIG. 2B is a flowchart illustrating a process for preventing TCP timeouts according to various embodiments;

FIG. 3 is a flowchart illustrating a process for determining PDU priorities according to various embodiments;

FIG. 4A illustrates the format of a network or IP packet header applicable to various embodiments;

FIG. 4B illustrates the format of a TCP packet header applicable to various embodiments;

FIG. 5 is a flowchart illustrating a process for preserving PDU priorities according to various embodiments;

FIG. 6 is a flowchart illustrating a process for determining macro priorities according to various embodiments; and

FIG. 7 is a flowchart illustrating a process for resolving conflicts according to various embodiments.

### DETAILED DESCRIPTION

While a number of embodiments are described herein, these embodiments are presented by way of example only, and are not intended to limit the scope of protection. The apparatuses and methods described herein may be embodied in a variety of other forms. Furthermore, various omissions, substitutions, and changes in the form of the example apparatuses and methods described herein may be made without departing from the scope of protection.

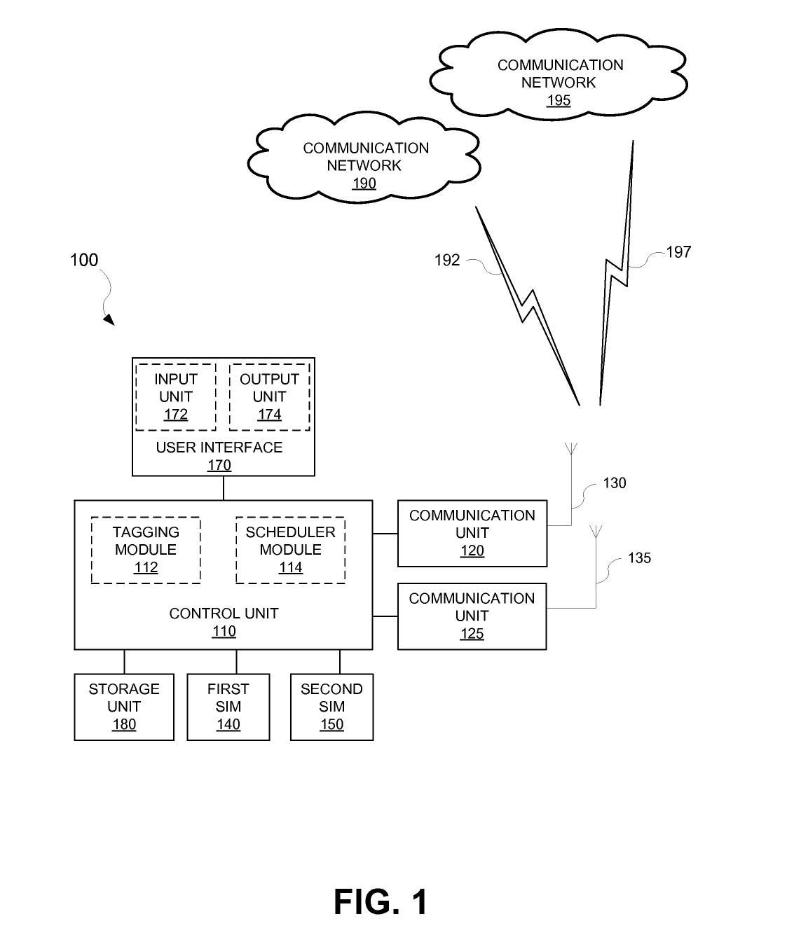

FIG. 1 is a block diagram illustrating a mobile communication device 100 according to various embodiments. Referring to FIG. 1, in various embodiments, a mobile communication device 100 may include a control unit 110, a first communication unit 120, a second communication unit 125, a first antenna 130, a second antenna 135, a first subscriber identity module (SIM) 140, a second SIM 150, a user interface 170, and storage unit 180.

In various embodiments, the mobile communication device 100 may be any device capable of wireless communicating with one or more communication networks. For example, in various embodiments, the mobile communication device 100 may be, for example, but not limited to, a smartphone, a tablet PC, or a laptop computer. Although the mobile communication device 100 is shown to include the first communication unit 120, the second communication unit 125, the first antenna 130, and the second antenna 135, a person of ordinary skill in the art can appreciate that the mobile communication device 100 may include more than two communication units and antennae without departing from the scope of the present inventive concept.

In various embodiments, the first SIM 140 may associate the first communication unit 120 with a first subscription 192 on a first communication network 190, and the she second SIM 150 may associate the second communication unit 125 with a second subscription 197 on a second communication network 195. For clarity and convenience, throughout this disclosure, the first subscription 192 is associated with the first communication unit 120 while the second subscription 197 is associated with the second communication unit 125. However, it is to be understood that either subscription may be associated with either communication unit without departing from the scope of the present inventive concept.

In various embodiments, the first communication network 190 and the second communication network 195 may be operated by the same or different service providers. Additionally, in various embodiments, the first communication network 190 and the second communication network 195 may each support the same or different communication technologies, including but not limited to Wideband Code Division Multiple Access (WCDMA), Global System for Mobile communications (GSM), Long Term Evolution (LTE), and Time Division-Synchronous Code Division Multiple Access (TD-SCDMA).

In various embodiments, the user interface 170 may include an input unit 172. In some embodiments, the input unit 172 may be, for example, but not limited to, a keyboard or a touch panel. In various embodiments, the user interface 170 may include an output unit 174. In some embodiments, the output unit 174 may be, for example, but not limited to, a liquid crystal display (LCD) or a light emitting diode (LED) display. A person of ordinary skill in the art will appreciate that other types or forms of input and output units may be used without departing from the scope of the present inventive concept.

In various embodiments, the control unit 110 may be configured to control the overall operation of the mobile communication device 100 including controlling the functions of the first communication unit 120, the second communication unit 125, the user interface 170, and the storage unit 180. In various embodiments, the control unit 110 may include a tagging module 112 and a scheduler module 114. In various embodiments, the control unit 110 may be, for example, but not limited to, a microprocessor or a microcontroller.

In various embodiments, the storage unit 180 may be configured to store application programs, application data, and user data. In various embodiments, at least some of the application programs stored at the storage unit 180 may be executed by the control unit 110 for the operation of the mobile communication device 100.

In various embodiments, the control unit 110 may be configured to arbitrate the uplink (Tx) and/or downlink (Rx) voice and data traffic associated with the first communication unit 120 and the second communication unit 125, and may be configured to detect and resolve conflicts (e.g., Tx/Tx and Rx/Tx) in the operation of the first communication unit 120 and the second communication unit 125.

Generally, an activity is assigned a default macro priority based on the type of channel that supports the activity. Some channels (e.g., traffic control channel (TCH)) are physical channels while others (e.g., common control channel (CCCH)) are logical. Each channel carries a certain type of data messages to and from a mobile communication device. For example, voice data exchanged during a phone call is typically conveyed as messages over the TCH while handover instructions to switch between channels are transmitted over the fast associated control channel (FACCH).

Activities performed over control channels (e.g., CCCH, FACCH) are generally preferred activities and are assigned a higher default macro priority than activities performed over other channels such as the TCH and the packet data traffic channel (PDTCH). For example, if one subscription is performing an uplink activity (i.e., Tx activity) over the PDTCH, such as a file transfer protocol (FTP) upload, and at the same time, another subscription is performing a Tx activity over FACCH, based on the default macro priorities associated with the corresponding activities, the subscription performing the FTP upload is required to inhibit its data transmission while the other subscription completes its Tx activity over the FACCH.

Various embodiments recognize individual PDU priorities in addition to or instead of the default macro priorities associated with different types of activities or channels. According to various embodiments, certain conflicting activities on separate subscriptions may be resolved based on PDU priorities. In various embodiments, the control unit 110 may be configured to determine and assign PDU priorities to individual PDUs transmitted from both communication units. A person of ordinary skill in the art can appreciate that the PDUs may communicate voice as well as data from both communication units.

Further, in the event of a conflict (e.g., Tx/Tx or Tx/Rx), the control unit 110 may be configured to inhibit the transmission from one communication unit on a selective basis. For example, the first communication unit 120 is performing a low macro priority PDTCH Tx activity while the second communication unit 125 is performing a high macro priority FACCH Tx activity. In various embodiments, the control unit 110 may be configured to selectively inhibit the transmission from the first communication unit 120 despite apparent conflict (e.g., Tx/Tx) and the inferior macro priority associated with the PDTCH Tx activity.

In some embodiments, the control unit 110 may be configured to cause the transmission of high PDU priority data on the first subscription 192 to take precedence over the transmission of low PDU priority data on the second subscription 197. In some embodiments, the control unit 110 may determine a macro priority for the Tx activity on the first subscription and a macro priority for the downlink (Rx) activity on the second subscription. The control unit 110 may be configured to defer low macro priority reception on the second subscription 197 in favor of the high macro priority transmission on the first subscription 192.

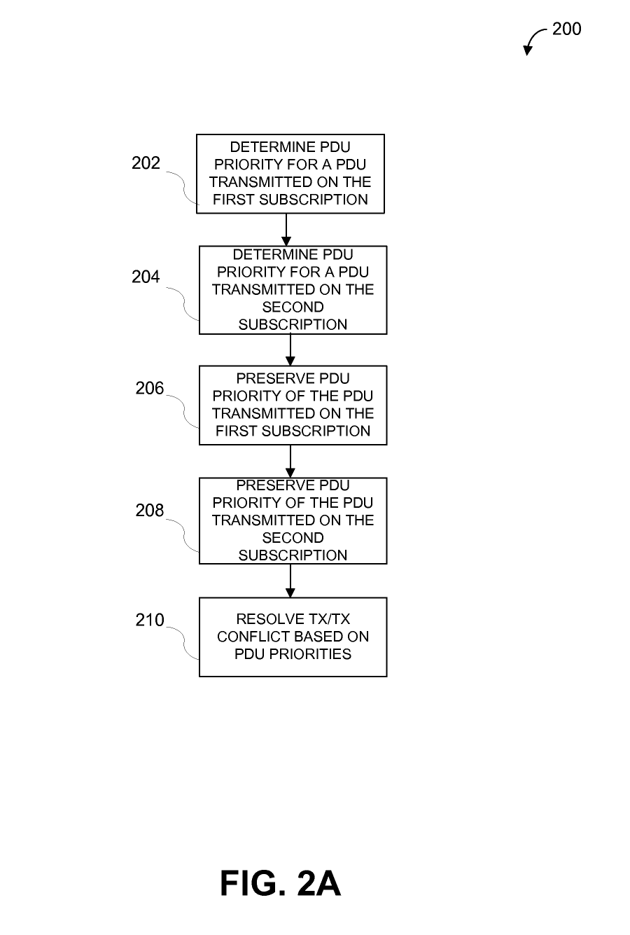

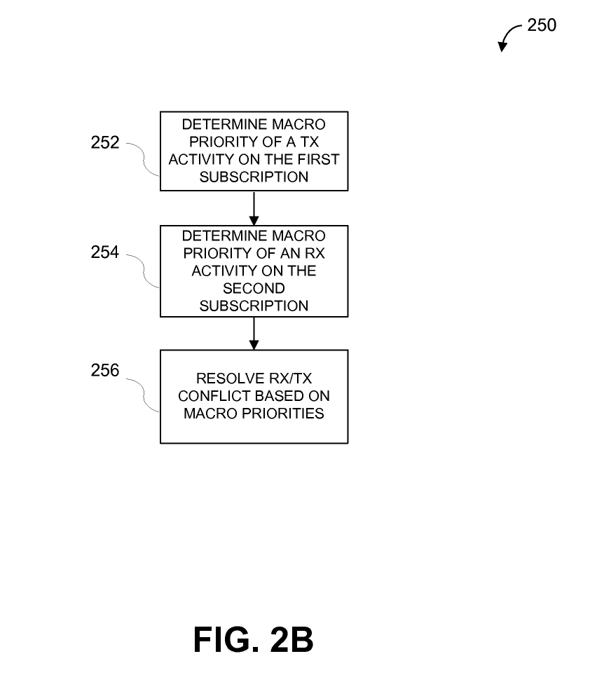

FIG. 2A is a flowchart illustrating a process 200 for preventing TCP timeouts according to various embodiments. In various embodiments, the process 200 may be performed by the control unit 110 (FIG. 1). Referring to FIGS. 1 and 2A, the control unit may determine the PDU priority for a PDU transmitted on the first subscription 192 (202). Also, the control unit 110 may determine the PDU priority for a PDU transmitted on the second subscription 197 (204). The control unit 110 may be configured to determine the priorities for PDUs that convey data from the first communication unit 120 and the second communication unit 125. Each PDU may be tagged with a respective PDU priority (e.g., high PDU priority, low PDU priority) by the control unit 110.

In various embodiments, the control unit 110 may cause the PDU priority of the PDU transmitted on the first subscription 192 to be maintained when each PDU is segmented into multiple transmission units (206). The control unit 110 may also cause the PDU priority of PDU transmitted on the second subscription 197 to be maintained when each PDU is segmented into multiple transmission units (208).

The control unit may be configured to resolve a Tx/Tx conflict based on the PDU priorities of the PDUs transmitted on both the first subscription 192 and the second subscription 197 (210). For example, the control unit 110 may determine which transmission (e.g., the first subscription 192 or the second subscription 197) takes precedence based on the PDU priorities associated with the transmission units conveyed on both the first subscription 192 and the second subscription 197.

A person of ordinary skill in the art can appreciate that the control unit 110 may perform at least some portions of the process 200 in an alternate order. For example, operation 202 may be performed in parallel to operation 204, and operation 206 may be performed in parallel to operation 208.

FIG. 2B is a flowchart illustrating a process 250 for preventing TCP timeouts according to various embodiments. With reference to FIGS. 1-2B, in various embodiments, the process 250 may be performed by the control unit 110. In various embodiments, the control unit 110 may determine the macro priority of a Tx activity on the first subscription 192 (252). The control unit 110 may also determine the macro priority of an Rx activity on the second subscription 194 (254).

The control unit 110 may be configured to resolve Rx/Tx conflicts based on the macro priority of the Tx activity on the first subscription 192 and macro priority of the Rx activity on the second subscription 197 (258). For example, the control unit 110 may determine which of the first subscription 192 or the second subscription 197 takes precedence based on the respective macro priorities of the Tx activity on the first subscription 192 and the Rx activity on the second subscription 197.

A person of ordinary skill in the art can appreciate that the control unit 110 may perform at least some portions of the process 250 in an alternate order. For example, operations 252 and 254 may be performed in parallel.

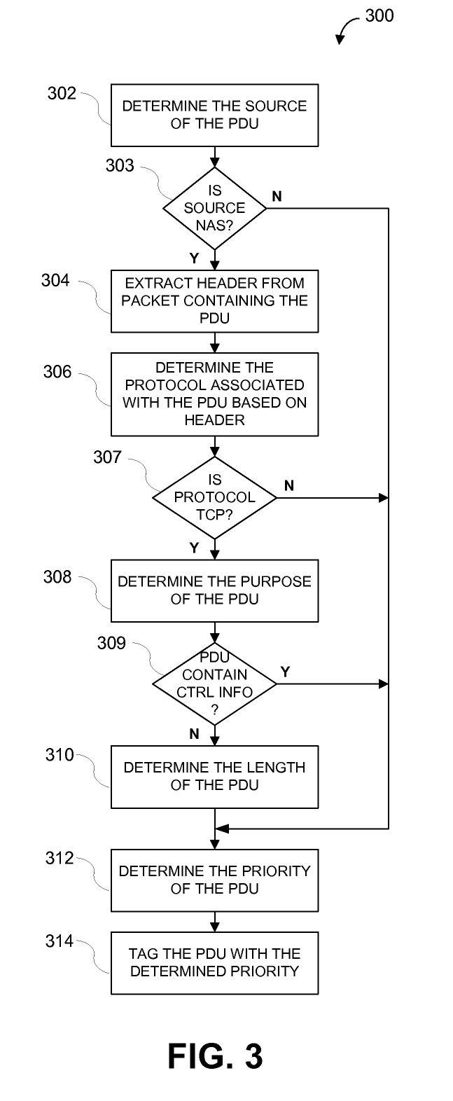

FIG. 3 is a flowchart illustrating a process 300 for determining PDU priorities according to various embodiments. The process 300 may be performed by the control unit 110 (FIG. 1), for example by the tagging module 112, and may implement operations 202 and 204 of the process 200 described with respect to FIG. 2A, and operation 252 of the process 250 described with respect to FIG. 2B.

Referring to FIGS. 1-3, the source of the PDU may be determined (302). In various embodiments, the control unit 110 may determine the source of the PDU based on the service access point identifier (SAPI) associated with the PDU. In some embodiments, the control unit 110 may determine the PDU priority based on the source of the PDU. If the PDU originates from the Non-Access Stratum (NAS) (303-Y), the control unit 110 may determine that the PDU has a high PDU priority.

If the PDU does not originate from the NAS (303-N), the control unit 110 may extract the header of the network or IP packet containing the PDU (304). The control unit 110 may determine the protocol associated based on the network or IP packet header (306). The packet payload of a network or IP packet may include data that have been further encapsulated according to different protocols, for example, but not limited to, TCP, ICMP, or user datagram protocol (UDP).

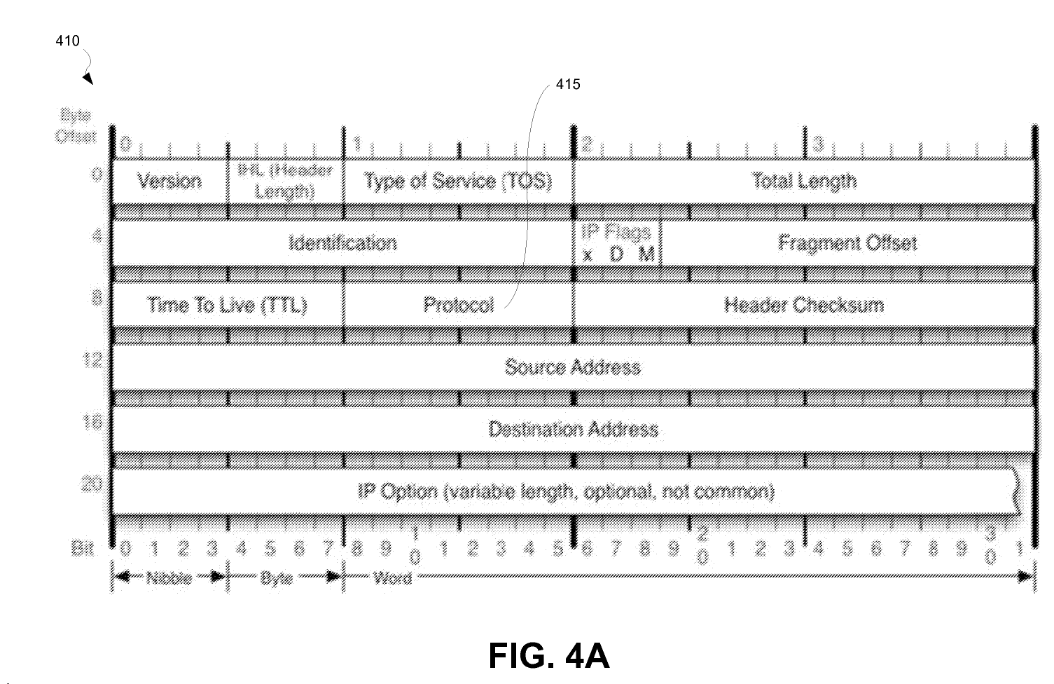

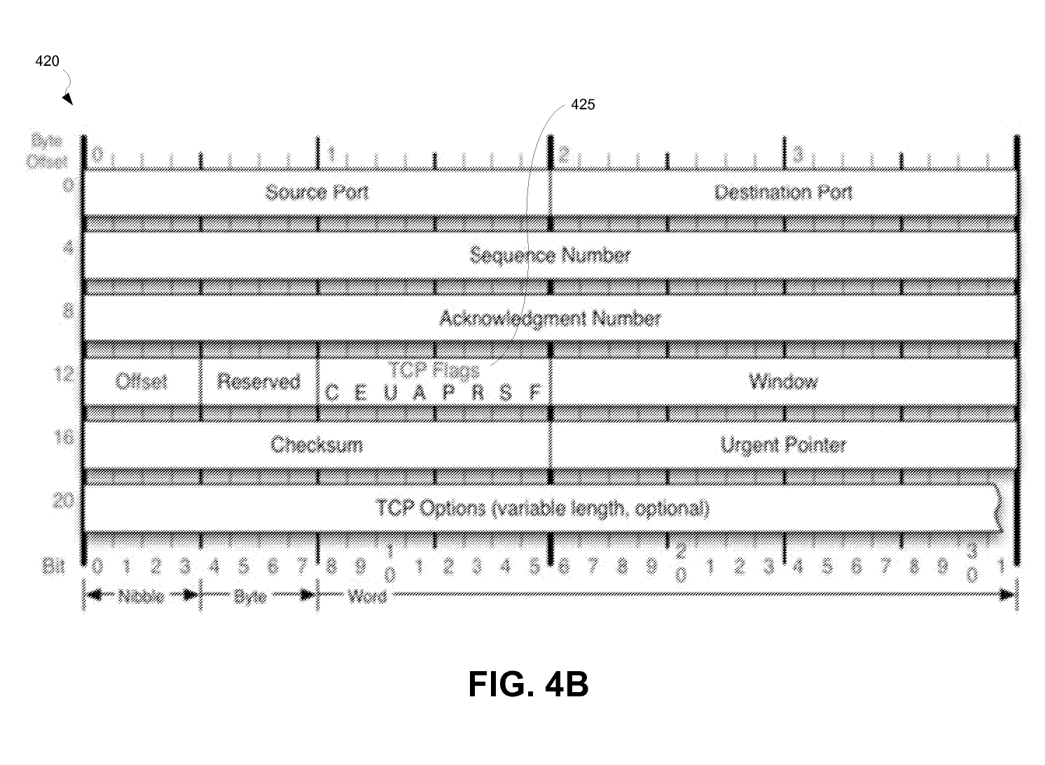

FIG. 4A illustrates the format of a network or IP packet header applicable to various embodiments. Referring to FIGS. 1-4A, a network or IP packet header 410 includes a “Protocol” field 415 that indicates the protocol used to encapsulate the data in the payload section of the network or IP packet. The control unit 110 may extract the IP protocol ID from the “Protocol” field 415 of the packet header 410, and determine, based on the value of the IP protocol ID in the “Protocol” field 415, whether the protocol used to encapsulate the packet payload is, for example, but not limited to, a TCP, ICMP, or UDP packet.

In some embodiments, the control unit 110 may determine the PDU priority based on the protocol used to encapsulate the payload of the network or IP packet. If the packet payload is determined to be a UDP packet (307-N), the control unit 110 may determine that the corresponding PDU (i.e., UDP datagram) has a low PDU priority. If the packet payload is determined to be an ICMP packet (307-N), for example, but not limited to, echo request, echo reply, etc., the control unit 110 may determine that the corresponding PDU has a high PDU priority.

In various embodiments, payload of the network or IP packet may be determined to be a TCP packet (307-Y) and the priority of the PDU (e.g., TCP segment) may be determined based on the purpose of the PDU. In various embodiments, the control unit 110 may determine the purpose of the PDU by identifying one or more set TCP flags in the header of the TCP packet encapsulated in the network or IP packet (308).

FIG. 4B illustrates the format of a TCP packet header applicable to various embodiments. Referring to FIGS. 1-4B, a TCP packet header 420 includes a “TCP Flags” field 425. In various embodiments, one of the TCP flags in the “TCP Flags” field 425 may be set, indicating that the corresponding PDU (i.e., TCP segment) conveys control information.

A set TCP flag may indicate that the purpose of the PDU is to convey control information such as congestion window reduced (CWR), explicit congest notification echo (ECE), URGENT, ACK, PUSH, RESET, synchronize (SYN), and finish (FIN). For example, a TCP packet that is commonly dispatched during a TCP connection (i.e., 3-way handshake) or data transfer is set with the acknowledgment (ACK) flag. If the purpose of the PDU is determined to convey control information (309-Y), the control unit 110 may determine that the PDU has a high PDU priority.

In some embodiments, the purpose of the PDU may not be to convey control information (309-N). As such, the control unit 110 may determine the priority of the PDU based on the length of the PDU. The control unit 110 may determine the length of the PDU (310). For example, the control unit 110 may determine that the PDU contains a certain number of octets of data. For example, if the length of the data in the PDU is more than or equal to a threshold amount (e.g., 100 octets), the control unit 110 may determine that the PDU has a low PDU priority. If the length of the data in the PDU is less than the threshold amount (e.g., 100 octets), the control unit 110 may determine that the PDU has a high PDU priority.

Once the control unit 110 determines the PDU priority of the PDU (312), the control unit 110 may subsequently tag the PDU with the PDU priority (314). In various embodiments, the control unit 110 may tag a PDU by associating the PDU with an additional priority parameter. In some embodiments, the control unit 110 may be configured to tag PDUs associated with the first subscription 192 with one set of PDU priorities and PDUs associated with the second subscription 197 with a different set of PDU priorities (such as an interleaved set of PDU priorities).

A person of ordinary skill in the art can appreciate that the control unit 110 may perform at least some portions of the process 300 in an alternate order. For example, in some embodiments, the control unit 110 may be configured to determine the length of the data in the PDU (310) before determining the purpose of the PDU (308).

The process 300 may be repeated multiple times for a plurality of PDUs. In various embodiments, concurrent but independent instances of the process 300 may be performed with respect to PDUs transmitted on the first subscription 192 and with respect to PDUs transmitted on the second subscription 197.

In various embodiments, the control unit 110 may tag PDUs from the first communication unit 120 and the second communication unit 125 with two different and interleaved sets of PDU priorities. TABLE 1 shows an example of two interleaved sets of PDU priorities.

TABLE 1
Interleaved Priority Sets.

| | FIRST | SECOND |
|---|---|---|
| PDU PRIORITY | SUBSCRIPTION | SUBSCRIPTION |
| HIGH_TIER | 3 | 2 |
| LOW_TIER | 1 | 0 |

Referring to TABLE 1, the HIGH_TIER PDU priority (high PDU priority) and LOW_TIER PDU priority (low PDU priority) for the first subscription 192 and the second subscription 197 are associated with different numerical values. If the control unit 110 detects a conflict (e.g., Tx/Tx or Rx/Tx) between activities on the first subscription 192 and the second subscription 197, HIGH_TIER priority PDUs conveyed on the first subscription 192 may take precedence over HIGH_TIER and LOW_TIER priority PDUs conveyed on the second subscription 197 based on the respective PDU priorities. As a result, the first subscription 192 may transmit a PDU that is tagged with a HIGH_TIER priority even though another HIGH_TIER priority PDU is also being conveyed on the second subscription 197. However, the second subscription 197 may transmit a HIGH_TIER priority PDU while a LOW_TIER priority PDU is being conveyed on the first subscription 192.

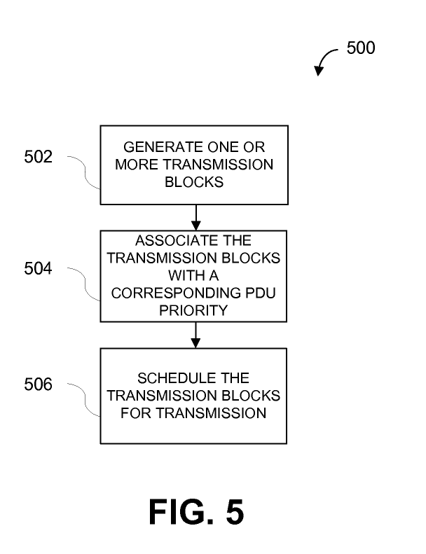

FIG. 5 is a flowchart illustrating a process 500 for preserving PDU priorities according to various embodiments. The process 500 may be performed by the control unit 110 (FIG. 1), for example by the tagging module 112. The process 500 may implement operations 206 and 208 of the process 200 described with respect to FIG. 2A. The process 500 may be performed subsequent to operation 314 described with respect to FIG. 3.

Referring to FIGS. 1-5, the control unit 110 may generate one or more transmission blocks (502). A radio link control/media access control (RLC/MAC) block is a basic type of transmission unit for the exchange of data between the mobile communication device 100 and any of the first communication network 190 and the second communication network 195. In various embodiments, the control unit 110 may segment individual PDUs into a plurality of transmission blocks. For example, the control unit 110 may segment a single PDU into two or more RLC/MAC blocks.

The control unit 110 may associate the transmission blocks with a corresponding PDU priority (504). In various embodiments, the RLC/MAC blocks generated from a PDU may inherit the priority of the PDU. For example, a UDP datagram may be tagged with a low PDU priority. The control unit 110 may associate the RLC/MAC blocks generated from the UDP datagram with the low PDU priority of the UDP datagram. For example, the control unit 110 may associate the RLC/MAC blocks generated from an ICMP packet with the same high PDU priority of the ICMP PDU.

The control unit 110 may schedule the transmission blocks for transmission (506). In various embodiments, the control unit 110 may schedule one or more RLC/MAC blocks for transmission by relaying the RLC/MAC blocks along with the corresponding PDU priority from the tagging module 112 to the scheduler module 114. In various embodiments, the control unit 110 may relay new RLC/MAC blocks that have not already been transmitted. The control unit 110 may also relay retransmission or negatively acknowledged (NACK'ed) RLC/MAC blocks.

The process 500 may be repeated multiple times for a plurality of PDUs. In various embodiments, concurrent but independent instances of the process 500 may be performed with respect to PDUs associated with the first subscription 192 on the first communication unit 120 and with respect to PDUs associated with the second subscription 197 on the second communication unit 125.

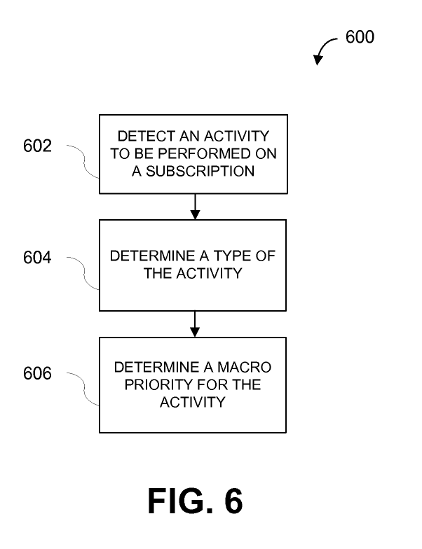

FIG. 6 is a flowchart illustrating a process 600 for determining Rx activity priorities according to various embodiments. The process 600 may be performed by the control unit 110 (FIG. 1). The process 600 may implement operations 252 and 254 of the process 250 described with respect to FIG. 2B.

Referring to FIGS. 1, 2B, and 6, the control unit 110 may detect an Rx activity anticipated to be performed by one of the first subscription 192 and the second subscription 197 (602). The control unit 110 may determine a type of the anticipated Rx activity (604). In various embodiments, the control unit 110 is configured to determine a type of the anticipated Rx activity based on patterns of repetition associated with different types of Rx and Tx activities.

Different types of data are transmitted and received in bursts, which correspond to the logical channel or type of the activity. Thus, the control unit 110 may anticipate when certain types of activities occur based on the pattern of repetition associated with different types of Rx and Tx activities. Some channel types, for example, but not limited to, PTCCH, SACCH, and SDCCH, occur with specific repetition patterns. For example, one burst of inbound FACCH data typically follows two bursts of outbound TCH data. If the control unit 110 already observed two Tx activities over the TCH performed on the first subscription 192, then the control unit 110 may expect the next activity performed on the first subscription 192 to be an Rx activity over the FACCH.

The control unit 110 may determine a macro priority for the anticipated Rx activity (606). In various embodiments, the macro priority associated with the activity may depend on the channel over which the activity is performed. For example, a Tx or an Rx activity performed over the FACCH may be assigned a higher macro priority than a Tx or an Rx activity performed over the PTCCH.

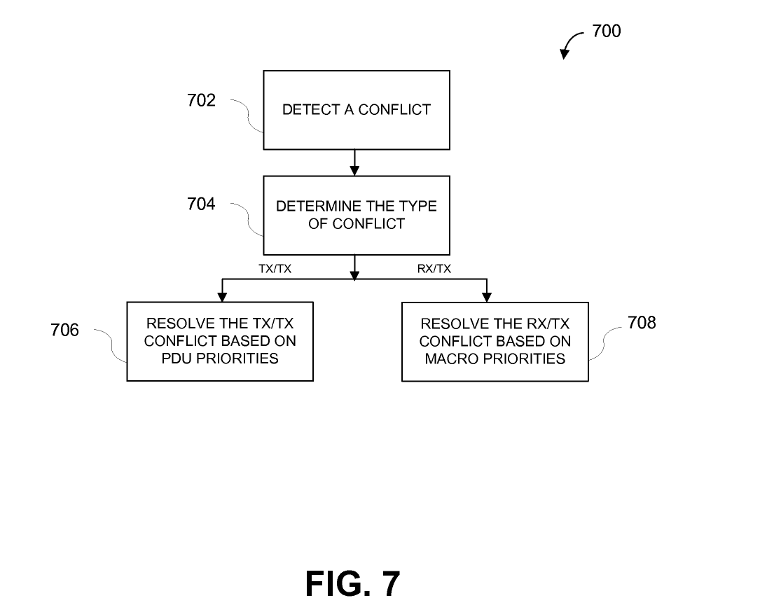

FIG. 7 is a flowchart illustrating a process 700 for resolving conflicts according to various embodiments. The process 700 may be performed by the control unit 110 (FIG. 1), for example by the scheduler module 114. The process 700 may implement operation 210 of the process 200 described with respect to FIG. 2A, and operation 256 of the process 250 described with respect to FIG. 2B. The process 700 may be performed subsequent to both operation 506 of the process 500 described with respect to FIG. 5 and operation 606 of the process 600 described with respect to FIG. 6.

Referring to FIGS. 1-7, the control unit 110 may detect a conflict (702) and determine the type of conflict (704). In various embodiments, the control unit 110 may be configured to detect conflicts that arise during the concurrent operation of the first communication unit 120 and the second communication unit 125 (702). For example, a conflict may arise when both the first communication unit 120 and the second communication unit 125 are engaged in a Tx activity. Alternately, a conflict may also arise if one of the two communication units (e.g., first communication unit 120) is engaged in a Tx activity while the other (e.g., second communication unit 125) is engaged in an Rx activity. The control unit 110 is configured to determine whether the detected conflict constitutes a Tx/Tx conflict or an Rx/Tx conflict (704).

When the conflict detected by the control unit 110 is a Tx/Tx conflict, the control unit 110 may resolve the Tx/Tx conflict based on PDU priorities (706). In various embodiments, the control unit 110 may compare the respective priorities of the RLC/MAC blocks associated with the transmission from each subscription. For example, the first subscription 192 may be performing a Tx activity over the low macro priority PDTCH, such as a file transfer protocol (FTP) upload, while the second subscription 197 may be performing another Tx activity over the high macro priority CCCH.

The content of the Tx activity performed on the first subscription 192 may include one or more ICMP packets and the content of the Tx data transfer performed on the second subscription 197 may include one or more UDP packets. The control unit 110 may defer the high macro priority CCCH Tx activity on the second subscription 197 in favor of the low macro priority PDTCH Tx activity on the first subscription 192 since the low macro priority PDTCH activity includes transmission of high PDU priority data. In some embodiments, the control unit 110 may require the second subscription 197 to inhibit its Tx data transfer in order to not interfere with the Tx data transfer performed on the first subscription 192.

When the conflict detected by the control unit is an Rx/Tx conflict, the control unit 110 may resolve the Rx/Tx conflict based on macro priorities (708).

In various embodiments, the control unit may resolve the Rx/Tx conflict based on the macro priority of the Tx activity performed on one subscription and the macro priority of the Rx activity performed on the other subscription (710). For example, the control unit 110 may allow a high macro priority Rx activity on the first subscription 192 to take precedence over a low macro priority Tx activity on the second subscription 197. The control unit 110 may also of high macro priority Tx activity on the first subscription 192 to prevail over a low macro priority Rx activity on the second subscription 197. For example, the low macro priority Rx activity on the second subscription 197 may be allowed to continue even though the Rx activity would be subject to interference from the high macro priority Tx activity on the first subscription 192.

The accompanying claims and their equivalents are intended to cover such forms or modifications as would fall within the scope and spirit of the protection. For example, the example apparatuses, methods, and systems disclosed herein may be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method, comprising:
determining a first protocol data unit (PDU) priority for a first PDU and a second PDU priority for a second PDU;
tagging the first PDU with the first PDU priority and the second PDU with the second PDU priority;
determining to transmit one of the first PDU and the second PDU based at least in part on the first PDU priority and the second PDU priority; and
transmitting a one of the first PDU and the second PDU having a higher PDU priority.

2. The method of claim 1, further comprising:
detecting a conflict between an uplink (Tx) activity performed by a first radio frequency (RF) chain transmitting the first PDU on a first subscription and a Tx activity performed by a second RF chain transmitting the second PDU on a second subscription; and
in response to detecting the conflict, resolving the conflict at least in part by determining to transmit the one of the first PDU on the first subscription and the second PDU on the second subscription having a higher PDU priority.

3. The method of claim 1, wherein determining the first PDU priority and the second PDU priority comprises:
determining a source of the first PDU and the second PDU; and
determining the first PDU priority and the second PDU priority based at least in part on the respective source of each of the first PDU and the second PDU.

4. The method of claim 1, wherein determining the source includes identifying a service access point identifier (SAPI) associated with each of the first PDU and the second PDU.

5. The method of claim 1, wherein determining at least one of the first PDU priority and the second PDU priority further comprises:
determining a protocol of at least one of the first PDU and the second PDU; and
determining at least one of the first PDU priority and the second PDU priority based at least in part on the protocol of at least one of the first PDU and the second PDU.

6. The method of claim 5, wherein determining the protocol includes extracting an IP Protocol ID from a header of a network packet comprising at least one of the first PDU and the second PDU.

7. The method of claim 1, wherein determining at least one of the first PDU priority and the second PDU priority further comprises:
determining a purpose of at least one of the first PDU and the second PDU; and
determining at least one of the first PDU priority and a second PDU priority based at least in part on the purpose of at least one of the first PDU and the second PDU.

8. The method of claim 7, wherein determining the purpose includes identifying at least one set Transmission Control Protocol (TCP) flag in a header of the TCP packet comprising at least one of the first PDU and the second PDU.

9. The method of claim 1, wherein determining at least one of the first PDU priority and the second PDU priority further comprises:
determining a length of at least one of the first PDU and the second PDU; and
determining at least one of the first PDU priority and the second PDU priority based at least in part on the length of at least one of the first PDU and the second PDU.

10. The method of claim 9, wherein determining the length includes determining a difference between a length of a TCP packet comprising at least one of the first PDU and a second PDU and a length of a corresponding header of the TCP packet.

11. The method of claim 1, further comprising:
segmenting the first PDU to generate a first plurality of transmission blocks, wherein the first plurality of transmission blocks include a first transmission block;
associating the first transmission block with the first PDU priority;
segmenting the second PDU to generate a second plurality of transmission blocks;
associating a second transmission block comprising the second plurality of transmission blocks with the second PDU priority; and
scheduling at least one of the first transmission block with the first PDU priority and the second transmission block with the second PDU priority for transmission.

12. A method, comprising:
determining a first macro priority for a first activity;
determining a second macro priority for a second activity;
determining to perform one of the first activity and the second activity based at least in part on the first macro priority and the second macro priority; and
performing a one of the first activity and the second activity.

13. The method of claim 12, further comprising:
detecting a conflict between the first activity performed by a first radio frequency (RF) on a first subscription and the second activity performed by a second RF chain on a second subscription;
in response to detecting the conflict, resolving the conflict at least in part by determining to perform the one of the first activity on the first subscription and the second activity on the second subscription having a higher macro priority.

14. The method of claim 13, wherein the conflict is detected when a one of the first activity and the second activity comprises a downlink (Rx) activity and another of the first activity and the second activity comprises an uplink (Tx) activity.

15. The method of claim 12, wherein determining the first macro priority and the second macro priority comprises:
determining a type of the first activity and the second activity; and
determining the first macro priority and the second macro priority based at least in part on the type of each of the first activity and the second activity.

16. The method of claim 15, wherein determining the type of the first activity and the second activity includes identifying a channel over which each of the first activity and the second activity is performed.

17. A mobile communication device, comprising:
a control unit configured to:
determine a first protocol data unit (PDU) priority for a first PDU and a second PDU priority for a second PDU;
tag the first PDU with the first PDU priority and the second PDU with the second PDU priority; and
determine to transmit one of the first PDU and the second PDU based at least in part on the first PDU priority and the second PDU priority; and
a first radio frequency (RF) chain; and
a second RF chain,
wherein one of the first RF chain and the second RF chain is configured to transmit a one of the first PDU and the second PDU having a higher PDU priority.

18. The mobile communication device of claim 17, wherein the control unit is further configured to:
detect a conflict between an uplink (Tx) activity performed by a first radio frequency (RF) chain transmitting the first PDU on a first subscription and a Tx activity performed by a second RF chain transmitting the second PDU on a second subscription; and
in response to detecting the conflict, resolve the conflict at least in part by determining to transmit the one of the first PDU on the first subscription and the second PDU on the second subscription having a higher PDU priority.

19. The mobile communication device of claim 17, wherein to determine the first PDU priority and the second PDU priority, the control unit is configured to:
determine a source of first PDU and the second PDU; and
determine the first PDU priority and the second PDU priority based at least in part on a respective source of each of the first PDU and the second PDU.

20. The mobile communication device of claim 19, wherein the control unit is configured to determine the source of the first PDU and the second PDU at least in part by identifying a service access point identifier (SAPI) associated with each of the first PDU and the second PDU.

21. The mobile communication device of claim 17, wherein to determine at least one of the first PDU priority and the second PDU priority, the control unit is further configured to:
determine a protocol of at least one of the first PDU and the second PDU; and
determine at least one of the first PDU priority and the second PDU priority, based at least in part on the respective protocol for each of the first PDU and the second PDU.

22. The mobile communication device of claim 21, wherein the control unit is configured to determine the protocol of at least one of the first PDU and the second PDU at least in part by extracting an IP Protocol ID from a header of a network packet comprising at least one of the first PDU and the second PDU.

23. The mobile communication device of claim 17, wherein to determine at least one of the first PDU priority and the second PDU priority, the control unit is further configured to:
determine a purpose of at least one of the first PDU and the second; and
determine at least one of the first PDU priority and a second PDU priority based at least in part on the purpose of at least one of the first PDU and the second PDU.

24. The mobile communication device of claim 23, wherein the control unit is configured to determine the purpose of at least one of the first PDU and the second PDU at least in part by identifying at least one set Transmission Control Protocol (TCP) flag in a header of the TCP packet comprising at least one of the first PDU and the second PDU.

25. The mobile communication device of claim 17, wherein to determine at least one of the first PDU priority and the second PDU priority, the control unit is further configured to:
determine a length of at least one of the first PDU and the second PDU; and
determine at least one of the first PDU priority and the second PDU priority based at least in part on the length of at least one of the first PDU and the second PDU.

26. The mobile communication device of claim 25, wherein the control unit is configured to determine the length of at least one of the first PDU and the second PDU based at least in part on a difference between a length of a TCP packet comprising at least one of the first PDU and the second PDU, and a length of a corresponding header of the TCP packet.

27. A mobile communication device, comprising:
a control unit configured to:
determine a first macro priority for a first activity;
determine a second macro priority for a second activity; and
determine to perform one of the first activity and the second activity based at least in part on the first macro priority and the second macro priority; and
a first radio frequency (RF) chain; and
a second RF chain,
wherein one of the first RF chain and the second RF chain is configured to perform a one of the first activity and the second activity having a higher macro priority.

28. The mobile communication device of claim 27, wherein the control unit is further configured to:
detect a conflict between the first activity performed by the first RF chain the activity performed by the second RF chain on a second subscription;
in response to detecting the conflict, resolve the conflict at least in part by determining perform the one of the first activity on the first subscription and the second activity on the second subscription having a higher macro priority.

29. The mobile communication device of claim 28, wherein the conflict is detected when a one of the first activity and the second activity comprises an uplink (Tx) activity and another of the first activity and the second activity comprises a downlink (Rx) activity.

30. The mobile communication device of claim 27, wherein to determine the first macro priority and the second macro priority, the control unit is configured to:
determine a type of the first activity and the second activity; determine the first macro priority and the second macro priority based at least in part on the type of each of the first activity and the second activity,
wherein the control unit is configured to determine the type of the first activity and the second activity at least in part by identifying a channel over which each of the first activity and the second activity is performed.
